(19) United States
(12) Patent Application Publication
(10) Pub. No.: US 2003/0212184 A1
(43) Pub. Date: Nov. 13, 2003

(54) Optical polymer densification process and product made therefrom

(76) Inventors: Yu-Ling Hsiao, Collegeville, PA (US); Anthony F. Garito, Radnor, PA (US)

Correspondence Address: Richard V. Burgujian, FINNEGAN, HENDERSON, FARABOW,, GARRETT & DUNNER, L.L.P., 1300 I Street, N.W., Washington, DC, 20005-3315, US

(21) Appl. No.: 10/347,272

(22) Filed: Jan. 21, 2003

Related U.S. Application Data
(60) Provisional application No. 60/349,791, filed on Jan. 18, 2002.

(51) Int. Cl. C08K 5/02

(52) U.S. Cl. 524/462

(57) ABSTRACT

The present invention is related to a process of making an optical polymer, comprising densifying a halogenated polymer by including therein at least one plasticizer in an effective amount so that the resulting optical polymer can exhibit a low optical loss, such as less than 0.5 dB/cm; and an optical polymer made therefrom and its use in optical devices; as well as a process of making an optical polymer film, which can be a substantially microporous free structure and can exhibit a low optical loss.

### CROSS-REFERENCE TO RELATED APPLICATION

This application claims the benefit of priory under 35 U.S.C. § 119(e) to U.S. Provisional Application 60/349,791 filed Jan. 18, 2002.

### FIELD OF THE INVENTION

The present invention is related to a process of making an optical polymer, comprising densifying a halogenated polymer by including therein at least one plasticizer in an amount effective to produce an optical polymer exhibiting a low optical loss. The present invention is also related to the optical polymer obtained from the process, as well as optical devices containing the optical polymer. In addition, the present invention is related to a process of making an optical polymer film, such as spin coating, wherein the resulting optical polymer film can be a substantially microporous free structure and can exhibit a low optical loss.

### BACKGROUND OF THE INVENTION

It is well established that optical fibers and planar waveguides made of typical hydrocarbon polymers commonly exhibit relatively high optical signal attenuation due to the optical absorption loss.

These absorptions primarily originate from overtones of fundamental molecular vibrations within the hydrocarbon polymers. Many of these absorption overtones fall within the range of wavelengths used in standard telecommunication applications. For example, the highly absorptive overtones associated with C—H bonds of the hydrocarbon polymers fall within the range of wavelengths of 850, 1310, and 1550 nm used in telecommunications. Further, these absorptive overtones can cause the hydrocarbon polymers to physically or chemically degrade, thereby leading to additional and often times permanent increase in signal attenuation in the optical fibers or waveguides.

Halogenated polymers have been shown to have potential to be used in the optical field. Halogenated polymers, such as fluoropolymers, are well known to exhibit characteristic microporous structures. For example, a fluoropolymer thin film prepared by solution spin casting can frequently exhibit an asymmetric membrane structure containing a relatively dense skin layer accompanied by a porous bottom layer with varying degree of porosity. However, in the optical field, the presence of such microporous structures in these halogenated polymer films can ultimately cause light to scatter in optical waveguides from these thin films, thereby resulting in significant optical signal attenuation. It is, therefore, important to form a dense film with little, or no, microporous structures and with low optical loss. In the known processes of solution spin casting, the use of various halogenated solvents, such as fluorinated solvents, and/or changes of baking conditions could not overcome this problem.

In the chemical processing field, it has been known to use plasticizers to enhance processibility of polymers. For example, highly fluorinated polymers can be difficult to process by conventional techniques, such as melt processing, because of their high molecular weight and intractability. U.S. Pat. No. 5,356,986, the contents of which are herein incorporated by references, for example, discloses the use of high-boiling, highly-fluorinated, polycyclic alkane as a plasticizer to enhance processibility, e.g., to facilitate ram extrusion, of fluoroelastomers and fluoroplastics. At the same time, the plasticized fluoroelastomers and fluoroplastics can be dimensionally stable and do not sag or slump or otherwise change shape perceptibly for a period of time, e.g., within four hours.

### SUMMARY OF THE INVENTION

Therefore, to overcome at least one of the above-mentioned problems or disadvantages in the optical field, the present inventors have surprisingly found that by inclusion of at least one plasticizer, such as a fluoroplasticizer, into a halogenated polymer, such as a fluoropolymer, the resulting polymer can exhibit a low optical loss, such as less than 0.5 dB/cm, further such as equal to or less than 0.2 dB/cm. The present invention thus relates to a process of making an optical polymer, comprising densifying a halogenated polymer, such as a fluoropolymer, by including therein at least one plasticizer in an effective amount so that the resulting optical polymer can exhibit a low optical loss. The present invention also relates to the resulting optical polymer and use of the resulting optical polymer to make optical devices. For example, the resulting optical polymer can be used to make a planar waveguide with an optical wavelength ranging, for example, from 800 nm to 3000 nm, such as from 1200 nm to 1700 nm. The present invention further relates to a process of making an optical polymer film, which can be substantially free of microporous structures and can exhibit a low optical loss.

In one embodiment, a process of making an optical polymer, comprises densifying a fluoropolymer by including therein at least one fluoroplasticizer, such as perfluorotetradecahydrophenanthrene oligomer, in an amount effective to produce an optical polymer exhibiting a low optical loss, such as less than 0.5 dB/cm, further such as equal to or less than 0.2 dB/cm.

### BRIEF DESCRIPTION OF THE DRAWINGS

In the drawings:

FIGS. 1A-1D are Scanning Electron Microscope (SEM) photograph showing various layers of a spin-coated optical polymer according to the present invention.

FIGS. 2A-2C are SEM photographs showing various layers of a spin-coated optical polymer according to the present invention.

FIG. 3 is a SEM photograph showing a 1.4 μm thick layer of a spin-coated polymer according to a known technique.

### DETAILED DESCRIPTION OF THE INVENTION

Disclosed herein is a process of making an optical polymer, comprising densifying a halogenated polymer, such as a fluoropolymer, by including therein at least one plasticizer in an amount effective to produce an optical polymer exhibiting a low optical loss.

As disclosed herein, the term “densifying” means removing or eliminating at least one microporous structure intrinsically existing in the halogenated polymer film prior to the addition of the at least one plasticizer.

Further as disclosed herein, the term “optical polymer” means a polymer or a polymeric composition, which is applicable to be used in the optical field, such as to make an optical device. Optical devices include, for example, passive waveguides, active waveguides, fibers, lens, pellicles, coatings, and displays. The optical polymer can be, for example, suitable for transmitting light in optical waveguides and for other optical applications. In general, the optical polymer according to the present invention can exhibit a low optical loss, such as less than 0.5 dB/cm, further such as equal to or less than 0.2 dB/cm, compared to the halogenated polymer prior to the addition of the at least one plasticizer.

Even further as disclosed herein, the term “optical loss,” including both absorption loss and scattering loss, means a slab waveguide loss, which can be measured according to a process commonly known to one of ordinary skill in the art, for example, the process disclosed in Chia-Chi Teng, Precision Measurements of the Optical Attenuation Profile along the Propagation Path in Thin-film Waveguides, APPLIED OPTICS, vol. 32, No. 7, Mar. 1, 1993, pages 1051-1054.

The halogenated polymer disclosed herein may, for example, be chosen from halogenated elastomers, perhalogenated elastomers, halogenated plastics, and perhalogenated plastics.

In one embodiment, the halogenated polymer is chosen from polymers, copolymers, and terpolymers comprising at least one halogenated monomer represented by one of the following formulas:

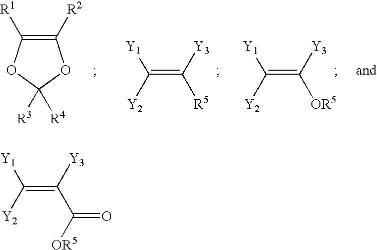

wherein R¹, R², R³, R⁴, and R⁵, which may be identical or different, are each chosen from linear and branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane; Y₁ and Y₂, which may be identical or different, are each chosen from H, F, Cl, and Br atoms; and Y₃ is chosen from H, F, Cl, and Br atoms, CF₃, and CH₃.

Alternatively, the polymer may comprise a condensation product made from the monomers listed below:

HO—R—OH+NCO—R′—NCO; or

HO—R—OH+Ary¹-Ary²,

wherein R and R′, which may be identical or different, are each chosen from halogenated alkylene, halogenated siloxane, halogenated ether, halogenated silylene, halogenated arylene, halogenated polyether, and halogenated cyclic alkylene; and Ary¹ and Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the halogenated polymer may also be chosen from halogenated cyclic olefin polymers, halogenated cyclic olefin copolymers, halogenated polycyclic polymer, halogenated polyimides, halogenated polyether ether ketones, halogenated epoxy resins, halogenated polysulfones, and halogenated polycarbonates.

The halogenated polymer, such as fluorinated polymer, may exhibit very little absorption loss over a wide wavelength range. Therefore, such fluorinated polymer materials may be suitable for optical applications.

In one embodiment, the halogenated aryl, alkyl, alkylene, alkylene ether, alkoxy, siloxane, ether, polyether, thioether, silylene, and silazane groups are at least partially halogenated, meaning that at least one hydrogen in the group has been replaced by a halogen. In another embodiment, at least one hydrogen in the group may be replaced by fluorine. Alternatively, these aryl, alkyl, alkylene, alkylene ether, alkoxy, siloxane, ether, polyether, thioether, silylene, and silazane groups may be completely halogenated, meaning that each hydrogen of the group has been replaced by a halogen. In an exemplary embodiment, the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may comprise from 1 to 12 carbon atoms.

Additionally, the halogenated polymer may comprise at least one functional group such as phosphinates, phosphates, carboxylates, silanes, siloxanes, sulfides, including, for example, POOH, POSH, PSSH, OH, SO₃H, SO₃R, SO₄R, COOH, NH₂, NHR, NR₂, CONH₂, and NH—NH₂, wherein R is chosen, for example, from aryl, alkyl, alkylene, siloxane, silane, ether, polyether, thioether, silylene, and silazane. Further, the halogenated polymer may also be chosen from homopolymers and copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. In another embodiment, the halogenated polymer is chosen from hydrogen-containing fluoroelastomers, hydrogen-containing perfluoroelastomers, hydrogen containing fluoroplastics, perfluorothermoplastics, fluoropolymers, and cross-linked halogenated polymers.

Examples of the halogenated polymer include poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, perfluorosulfonate ionomer, such as fluorinated Nafion®, and fluorinated poly(phenylenevinylene).

The plasticizer used according to the present invention is chosen from linear, branched, cyclic, and polycyclic halogenated alkanes and the associated oligomers thereof having more than 22 carbon atoms. Such compounds advantageously have a high boiling point, for example, of over 200° C., such as ranging from 250° C. to 500° C., at ambient pressure. In one embodiment, the plasticizer is chosen from perhalogenated compounds. In contrast to linear, branched, or cyclic compounds, the term “polycyclic compounds” means carbon-based compounds chosen, for example, from carbon-based compounds comprising at least two rings, which may be identical or different, chosen from saturated and unsaturated, fused and unfused, 3-, 4-, 5-, 6-, 7-, and 8-membered rings, optionally substituted with at least one entity chosen from alkyl radicals, aryl radicals, functional groups, and hetero atoms chosen, for example, from halogen atoms, such as F, Cl, and Br.

The alkyl radicals are chosen, for example, from linear, branched and cyclic, saturated and unsaturated alkyl radicals comprising, for example, from 1 to 20 carbon atoms, optionally comprising at least one hetero atom chosen from halogen atoms, such as F, Cl, and Br, and P, O, N, and S atoms. The aryl radicals are chosen from those comprising, for example, from 6 to 20 carbon atoms, optionally substituted with at least one entity chosen from the alkyl radicals as defined above and hetero atoms, such as halogen atoms (such as F, Cl, and Br), P, O, N, and S. The functional groups are chosen, for example, from alcohol, primary amine, secondary amine, and thiol functional groups.

In one embodiment, the halogenated polycyclic compounds are chosen from perfluourinated polycyclic compounds. In another embodiment, the halogenated polycyclic compounds are chosen from highly fluorinated polycyclic alkanes with high boiling point. For example, the highly-fluorinated polycyclic alkances include fluoroalicyclic oligomers such as those derived from the fluorination of phenanthrene. The fluoroalicyclic oligomers derived from the fluorination of phenanthrene can be, for example, perfluorotetradecahydrophenanthrene oligomer. In one embodiment, the at least one plasticizer is chosen from perfluorotetradecahydrophenanthrene oligomers.

In the process of making an optical polymer according to the present invention, the plasticizer is in an amount effective to produce an optical polymer having a low optical loss, such as less than 0.5 dB/cm, further such as equal to or less than 0.2 dB/cm.

In one embodiment, the plasticizer is in an amount ranging from 2% to 50% by weight relative to the weight of the solid halogenated polymer used in the process. For example, the plasticizer is in an amount ranging from 5% to 50%, such as from 5% to 30%, further such as from 5% to 20% by weight relative to the weight of the solid halogenated polymer used in the process.

Further disclosed herein is a process of making an optical polymer film comprising spin coating a solution comprising, in a medium suitable for the spin coating, the halogenated polymer and the plasticizer onto a substrate, such as a silicon substrate; and then drying the coating solution using a gradual heating profile. One example of a heating profile is heating at 60° C. for 10 min, and then 80° C. for 10 min, and 120° C. for 2 hours. This profile has been shown to produce a film having a structure that is substantially free of microporous structure. Accordingly, the resulting polymer exhibits a low optical loss, such as less than 0.5 dB/cm, further such as equal to or less than 0.2 dB/cm. The existence of any microporous structure can be observed under Scanning Electron Microscope (SEM) in a manner known to the ordinary skill in the art.

The medium suitable for the spin coating can comprise at least one halogenated solvent chosen, for example, from halogenated polyethers, halogenated trialkyl amines and halogenated polycyclic compounds. The selection of the halogenated solvent depends on the nature and type of the halogenated polymer used therein.

The concentration of the halogenated polymer can be, for example, ranging from 2% to 30% by solid weight, relative to the total weight of the coating solution. For example, the concentration of the halogenated polymer ranges from 5% to 30%, such as 5% to 25% by solid weight, relative to the total weight of the coating solution. The concentration of the plasticizer, as discussed above, depends on the concentration of the solid halogenated polymer in the coating solution.

In one embodiment, the coating solution may comprise, for example, from 2% to 30 % by solid weight of a fluoropolymer, such as poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene], relative to the total weight of the coating solution, and from 2% to 50 % by weight of a fluoroplasticizer, such as perfluorotetradecahydrophenanthrene oligomer, relative to the total solid weight of the halogenated polymer in the solution. Depending on the nature and type of the fluoropolymer, at least one of fluorinated solvent, such as perfluoropolyether, perlfuoro-n-butyl-tetrahydrofuran, and perfluorotributylamine, may be used.

The coating solution may also comprise at least one other polymer, which is sufficiently clear for optical applications. For example, the at least one other polymer is chosen from fluoropolymers such as terpolymers of hexafluoropropylene, vinylidene fluoride and tetrafluoroethylene.

The coating solution may further comprise at least one inactive filler, for example, silica, coated silica, coated silica nanoparticles, and other metal oxide compounds.

A person skilled in the art will take care to select this or these optional additional compound(s), and/or the amount thereof, to be included in the coating solution, such that the advantageous properties of the process are not, or are not substantially, adversely affected by the envisaged addition.

Depending on the polymer concentration of the coating solution and the film forming property of the polymer in the coating solution, the spin-coating can be operated in a speed ranging, for example, from 500 rpm to 10000 rpm, for a period of time ranging, for example, from 10 seconds to 2 minutes.

The invention is illustrated in greater detail in the examples that follow.

### EXAMPLE 1

### According to the Invention

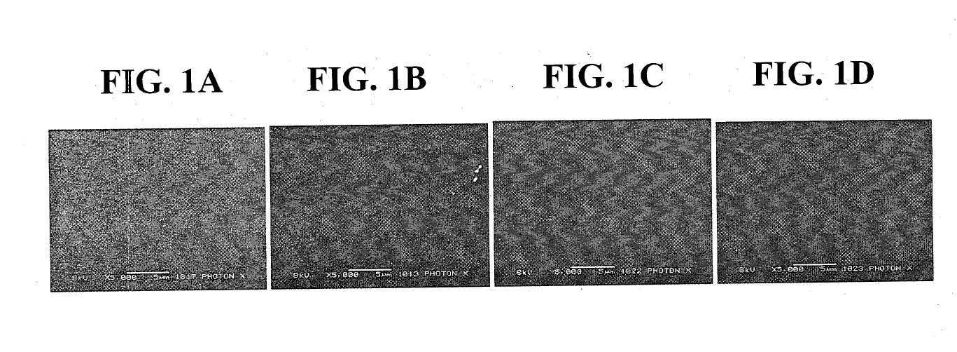

A combination of 85% by weight of solid poly[2,2,4-trifluoro-5-trifluoromethoxy-1,3-dioxole-co-tetrafluoroethylene] and 15% by weight of solid perfluorotetradecahydrophenanthrene oligomer with a boiling point of higher than 400° C. were dissolved in a hydrofluoropolyether solvent to form a coating solution with 15% by weight of solids. The solution was then spin coated at 1000 rpm for 10 seconds onto a silicon substrate and heated with a gradual heating profile of 60° C. for 10 minutes; 80° C. for 10 minutes; and 120° C. for 2 hours. The dried film was examined under the SEM layer by layer at the film's original thickness and after the film was etched to various depths to reveal the dense structure throughout the film as shown in FIGS. 1A-1D.

FIG. 1A shows the top of the film, which is approximately 5.52 microns thick. The film was then reactive ion etched a depth of approximately 1 micron to reveal an approximately 4.52 micron thick film, as shown in FIG. 1B. The film was again reactive ion etched a depth of approximately 1 micron to reveal an approximately 3.52 micron thick film, as shown in FIG. 1C. The film was reactive ion etched again a depth of approximately 1 micron to reveal an approximately 2.52 micron thick film, as shown in FIG. 1D. Virtually no porous structures were visible in all four figures from 1A to 1D.

The slab waveguide loss of the film was measured to reveal a value of 0.2 dB/cm.

### EXAMPLE 2

### According to the Invention

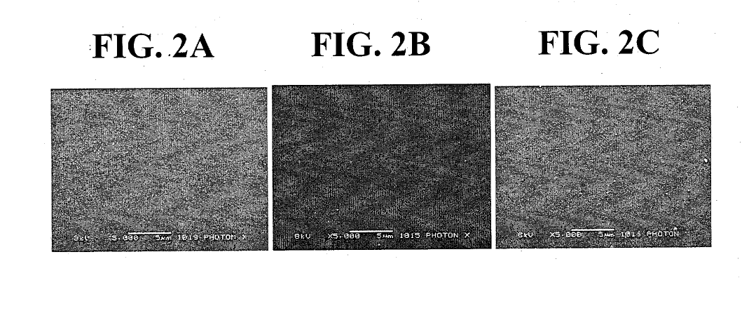

A combination of 70% by weight of solid poly[2,2,4-trifluoro-5-trifluoromethoxy-1,3-dioxole-co-tetrafluoroethylene] and 30% by weight of solid perfluorotetradecahydrophenanthrene oligomer with a boiling point of higher than 400° C. were dissolved in a hydrofluoropolyether solvent to form a coating solution with 15% by weight of solids. The solution was then spin coated under the same conditions as in Example 1. The dried film was examined under the SEM layer by layer at the film's original thickness and after the film was etched to various depths to reveal the dense structure throughout the film as shown in FIGS. 2A-2C.

FIG. 2A shows the top of the film, which is approximately 3.12 microns thick. The film was then reactive ion etched a depth of approximately 1 micron to reveal an approximately 2.12 micron thick film, as shown in FIG. 2B. The film was again reactive ion etched a depth of approximately 1 micron to reveal an approximately 1.12 micron thick film, as shown in FIG. 2C. Virtually no porous structures were visible in all three figures from 2A to 2C.

The slab waveguide loss of the film was measured to reveal a value of 0.2 dB/cm.

### EXAMPLE 3

### Comparative Example

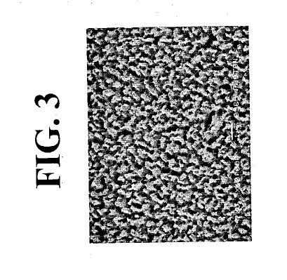

15% by weight of solid poly[2,2,4-trifluoro-5-trifluoromethoxy-1,3-dioxole-co-tetrafluoroethylene] was dissolved in perfluoropolyether solvent. The solution was then spin coated under the same condition as in Example 1. The dried film was examined layer by layer under the SEM. FIG. 3 shows the SEM microphoto of a 1.4 micron film of the comparative example. FIG. 3 reveals various microporous structures and a dense structure was not obtained throughout the film.

The slab waveguide loss of the film was measured to reveal a value of above 0.5 dB/cm.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as disclosed herein.

What is claimed is:

1. A process of making an optical polymer, comprising densifying a halogenated polymer by including therein at least one plasticizer in an effective amount so that the resulting optical polymer exhibits a low optical loss.

2. The process according to claim 1, wherein the at least one halogenated polymer is chosen from polymers, copolymers, terpolymers, and polymer blends comprising at least one halogenated monomer chosen from one of the following formulas: 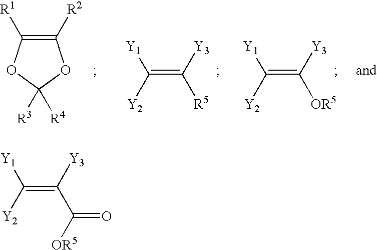
wherein,
R¹, R², R³, R⁴, and R⁵, which may be identical or different, are each chosen from linear and branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

3. The process according to claim 2, wherein R¹, R², R³, R⁴, and R⁵ are at least partially fluorinated.

4. The process according to claim 2, wherein R¹, R², R³, R⁴, and R⁵ are completely fluorinated.

5. The process according to claim 2, wherein at least one of R¹, R², R³, R⁴, and R⁵is chosen from C₁-C₁₀, linear and branched, saturated and unsaturated hydrocarbon-based chains.

6. The process according to claim 2, the at least one halogenated polymer is chosen from the condensation products of at least one of the following monomeric reactions:
HO—R—OH+NCO—R′—NCO; and
HO—R—OH+Ary¹-Ary²,
wherein
R and R′, which may be identical or different, are each chosen from halogenated alkylenes, halogenated siloxanes, halogenated ethers, halogenated silylenes, halogenated arylenes, halogenated polyethers, and halogenated cyclic alkylenes; and
Ary¹ and Ary², which may be identical or different, are each chosen from halogenated aryls and halogenated alkyl aryls.

7. The process according to claim 2, wherein the at least one halogenated polymer is chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

8. The process according to claim 2, wherein the at least one halogenated polymer comprises at least one functional group chosen from phosphinates, phosphates, carboxylates, silanes, siloxanes, and sulfides.

9. The process according to claim 2, wherein the at least one halogenated polymer is chosen from hydrogen-containing fluoroelastomers.

10. The process according to claim 2, wherein the at least one halogenated polymer is chosen from cross-linked halogenated polymers.

11. The process according to claim 2, wherein the at least one halogenated polymer is chosen from fluorinated polymers.

12. The process according to claim 2, wherein the at least one halogenated polymer is chosen from perhalogenated polymers.

13. The process according to claim 12, wherein the perhalogenated polymers are chosen from perfluorinated polymers.

14. The process according to claim 2, wherein the at least one halogenated polymer is chosen from perhalogenated elastomers.

15. The process according to claim 14, wherein the at least one halogenated polymer is chosen from perfluoroelastomer.

16. The process according to claim 2, wherein the at least one halogenated polymer is chosen from fluorinated plastics.

17. The process according to claim 2, wherein the at least one halogenated polymer is chosen from perfluorinated plastics.

18. The process according to claim 2, wherein the at least one halogenated polymer is chosen from a blend of halogenated polymers.

19. The process according to claim 2, wherein the at least one halogenated polymer is chosen from a blend of fluorinated polymers.

20. The process according to claim 2, wherein the at least one halogenated polymer is chosen a blend of perfluorinated polymers.

21. The process according to claim 2, wherein the at least one halogenated polymer is chosen from poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], and poly[2,2,4-trifluoro-5-trifluoromethoxy-1,3-dioxole-co-tetrafluoroethylene].

22. The process according to claim 2, wherein the at least one halogenated polymer is chosen from poly(pentafluorostyrene), fluorinated polyimide, fluorinated polymethylmethacrylate, polyfluoroacrylates, polyfluorostyrene, fluorinated polycarbonates, perfluoro-polycyclic polymers, fluorinated cyclic olefin polymers, and fluorinated copolymers of cyclic olefins.

23. The process according to claim 1, wherein the at least one plasticizer is chosen from linear, branched, cyclic, and polycyclic halogenated alkanes and the associated oligomers thereof having more than 22 carbon atoms.

24. The process according to claim 23, wherein the at least one plasticizer is chosen from linear, branched, cyclic, and polycyclic halogenated alkanes and the associated oligomers thereof having more than 22 carbon atoms with a high boiling point of over 200° C. at the ambient pressure.

25. The process according to claim 24, wherein the at least one plasticizer is chosen from linear, branched, cyclic, and polycyclic halogenated alkanes and the associated oligomers thereof having more than 22 carbon atoms with a high boiling point ranging from 250° C. to 500° C. at the ambient pressure.

26. The process according to claim 23, wherein the polycyclic halogenated alkanes are chosen from halogenated alkanes comprising at least two rings, which may be identical or different, chosen from saturated and unsaturated, fused and unfused, 3-, 4-, 5-, 6-, 7-, and 8-membered rings, optionally substituted with at least one entity chosen from alkyl radicals, aryl radicals, functional groups, and hetero atoms.

27. The process according to claim 26, wherein the alkyl radicals are chosen from linear, branched and cyclic, saturated and unsaturated alkyl radicals comprising from 1 to 20 carbon atoms, optionally comprising at least one hetero atom chosen from halogen atoms and P, O, N, and S atoms.

28. The process according to claim 26, wherein the aryl radicals are chosen from aryl radicals comprising from 6 to 20 carbon atoms, optional substituted with at least one entity chosen from alkyl radicals and hetero atoms chosen from halogen atoms and P, O, N, and S atoms, wherein the alkyl radicals are chosen from linear, branched and cyclic, saturated and unsaturated alkyl radicals comprising from 1 to 20 carbon atoms, optionally comprising at least one hetero atom chosen from halogen atoms and P, O, N, and S atoms.

29. The process according to claim 26, wherein the functional groups are chosen from alcohol, primary amine, secondary amine, and thiol functional groups.

30. The process according to claim 26, wherein the hetero atoms are chosen from halogen atoms.

31. The process according to claim 30, wherein the halogen atoms are chosen from F, Cl, and Br atoms.

32. The process according to claim 23, wherein the at least one plasticizer is chosen from perhalogenated polycyclic compounds.

33. The process according to claim 23, wherein the at least one plasticizer is chosen from fluorinated polycyclic compounds.

34. The process according to claim 33, wherein the at least one plasticizer is chosen from perfluorinated polycyclic compounds.

35. The process according to claim 33, wherein the at least one plasticizer is chosen from fluorinated polycyclic alkanes with a high boiling point of over 200° C.

36. The process according to claim 35, wherein the at least one plasticizer is chosen from fluoroalicyclic oligomers.

37. The process according to claim 36, wherein the at least one plasticizer is chosen from perfluorotetradecahydrophenanthrene oligomers.

38. The process according to claim 1, wherein the low optical loss is less than 0.5 dB/cm.

39. The process according to claim 38, wherein the low optical loss is equal to or less than 0.2 dB/cm.

40. The process according to claim 1, wherein the effective amount of the at least one plasticizer ranges from 2% to 50% by weight relative to the solid weight of the at least one halogenated polymer used in the process.

41. The process according to claim 40, wherein the effective amount of the at least one plasticizer ranges from 5% to 30% by weight relative to the solid weight of the at least one halogenated polymer used in the process.

42. The process according to claim 41, wherein the effective amount of the at least one plasticizer ranges from 2% to 20% by weight relative to the solid weight of the at least one halogenated polymer used in the process.

43. An optical polymer comprising at least one halogenated polymer and at least one plasticizer in an amount effective to produce an optical polymer having a substantially microporous free structure, wherein said optical polymer exhibits an optical loss of less than approximately 0.5 dB/cm.

44. The optical polymer according to claim 43, wherein said optical loss is equal to or less than approximately 0.2 dB/cm.

45. The optical polymer according to claim 43, wherein the at least one halogenated polymer is chosen from polymers, copolymers, terpolymers, and polymer blends comprising at least one halogenated monomer chosen from one of the following formulas: 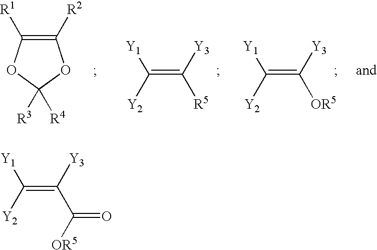
wherein,
R¹, R², R³, R⁴, and R⁵, which may be identical or different, are each chosen from linear and branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

46. The optical polymer according to claim 45, wherein R¹, R², R³, R⁴, and R⁵ are at least partially fluorinated.

47. The optical polymer according to claim 45, wherein R¹, R², R³, R⁴, and R⁵ are completely fluorinated.

48. The optical polymer according to claim 45, wherein at least one of R¹, R², R³, R⁴, and R⁵ is chosen from C₁-C₁₀, linear and branched, saturated and unsaturated hydrocarbon-based chains.

49. The optical polymer according to claim 45, the at least one halogenated polymer is chosen from the condensation products of at least one of the following monomeric reactions:
HO—R—OH+NCO—R′—NCO; and
HO—R—OH+Ary¹-Ary²,
wherein
R and R′, which may be identical or different, are each chosen from halogenated alkylenes, halogenated siloxanes, halogenated ethers, halogenated silylenes, halogenated arylenes, halogenated polyethers, and halogenated cyclic alkylenes; and
Ary¹ and Ary², which may be identical or different, are each chosen from halogenated aryls and halogenated alkyl aryls.

50. The optical polymer according to claim 45, wherein the at least one halogenated polymer is chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

51. The optical polymer according to claim 45, wherein the at least one halogenated polymer comprises at least one functional group chosen from phosphinates, phosphates, carboxylates, silanes, siloxanes, and sulfides.

52. The optical polymer according to claim 45, wherein the at least one halogenated polymer is chosen from hydrogen-containing fluoroelastomers.

53. The optical polymer according to claim 45, wherein the at least one halogenated polymer is chosen from cross-linked halogenated polymers.

54. The optical polymer according to claim 45, wherein the at least one halogenated polymer is chosen from fluorinated polymers.

55. The optical polymer according to claim 45, wherein the at least one halogenated polymer is chosen from perhalogenated polymers.

56. The optical polymer according to claim 55, wherein the perhalogenated polymers are chosen from perfluorinated polymers.

57. The optical polymer according to claim 45, wherein the at least one halogenated polymer is chosen from perhalogenated elastomers.

58. The optical polymer according to claim 57, wherein the at least one halogenated polymer is chosen from perfluoroelastomer.

59. The optical polymer according to claim 45, wherein the at least one halogenated polymer is chosen from fluorinated plastics.

60. The optical polymer according to claim 45, wherein the at least one halogenated polymer is chosen from perfluorinated plastics.

61. The optical polymer according to claim 45, wherein the at least one halogenated polymer is chosen from a blend of halogenated polymers.

62. The optical polymer according to claim 45, wherein the at least one halogenated polymer is chosen from a blend of fluorinated polymers.

63. The optical polymer according to claim 45, wherein the at least one halogenated polymer is chosen a blend of perfluorinated polymers.

64. The optical polymer according to claim 45, wherein the at least one halogenated polymer is chosen from poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], and poly[2,2,4-trifluoro-5-trifluoromethoxy-1,3-dioxole-co-tetrafluoroethylene].

65. The optical polymer according to claim 45, wherein the at least one halogenated polymer is chosen from poly(pentafluorostyrene), fluorinated polyimide, fluorinated polymethylmethacrylate, polyfluoroacrylates, polyfluorostyrene, fluorinated polycarbonates, perfluoro-polycyclic polymers, fluorinated cyclic olefin polymers, and fluorinated copolymers of cyclic olefins.

66. The optical polymer according to claim 43, wherein the at least one plasticizer is chosen from chosen from linear, branched, cyclic, and polycyclic halogenated alkanes and the associated oligomers thereof having more than 22 carbon atoms.

67. The optical polymer according to claim 66, wherein the at least one plasticizer is chosen from chosen from linear, branched, cyclic, and polycyclic halogenated alkanes and the associated oligomers thereof having more than 22 carbon atoms with a high boiling point of over 200° C. at the ambient pressure.

68. The optical polymer according to claim 67, wherein the at least one plasticizer is chosen from chosen from linear, branched, cyclic, and polycyclic halogenated alkanes and the associated oligomers thereof having more than 22 carbon atoms with a high boiling point ranging from 250° C. to 500° C. at ambient pressure.

69. The optical polymer according to claim 66, wherein the polycyclic halogenated alkanes are chosen from halogenated alkanes comprising at least two rings, which may be identical or different, chosen from saturated and unsaturated, fused and unfused, 3-, 4-, 5-, 6-, 7-, and 8-membered rings, optionally substituted with at least one entity chosen from alkyl radicals, aryl radicals, functional groups, and hetero atoms.

70. The optical polymer according to claim 69, wherein the alkyl radicals are chosen from linear, branched and cyclic, saturated and unsaturated alkyl radicals comprising from 1 to 20 carbon atoms, optionally comprising at least one hetero atom chosen from halogen atoms and P, O, N, and S atoms.

71. The optical polymer according to claim 69, wherein the aryl radicals are chosen from aryl radicals comprising from 6 to 20 carbon atoms, optional substituted with at least one entity chosen from alkyl radicals and hetero atoms chosen from halogen atoms and P, O, N, and S atoms, wherein the alkyl radicals are chosen from linear, branched and cyclic, saturated and unsaturated alkyl radicals comprising from 1 to 20 carbon atoms, optionally comprising at least one hetero atom chosen from halogen atoms and P, O, N, and S atoms.

72. The optical polymer according to claim 69, wherein the functional groups are chosen from alcohol, primary amine, secondary amine, and thiol functional groups.

73. The optical polymer according to claim 69, wherein the hetero atoms are chosen from halogen atoms.

74. The optical polymer according to claim 70, wherein the halogen atoms are chosen from F, Cl, and Br atoms.

75. The optical polymer according to claim 66, wherein the at least one plasticizer is chosen from perhalogenated polycyclic compounds.

76. The optical polymer according to claim 66, wherein the at least one plasticizer is chosen from fluorinated polycyclic compounds.

77. The optical polymer according to claim 66, wherein the at least one plasticizer is chosen from perfluorinated polycyclic compounds.

78. The optical polymer according to claim 66, wherein the at least one plasticizer is chosen from fluorinated polycyclic alkanes with a high boiling point of over 200° C.

79. The optical polymer according to claim 78, wherein the at least one plasticizer is chosen from fluoroalicyclic oligomers.

80. The optical polymer according to claim 79, wherein the at least one plasticizer is chosen from perfluorotetradecahydrophenanthrene oligomers.

81. The optical polymer according to claim 43, wherein said optical loss is less than approximately 0.5 dB/cm.

82. The optical polymer according to claim 81, wherein said optical loss is less than approximately 0.2 dB/cm.

83. The optical polymer according to claim 43, wherein the effective amount of the at least one plasticizer ranges from 2% to 50% by weight relative to the solid weight of the at least one halogenated polymer used in the process.

84. The optical polymer according to claim 83, wherein the effective amount of the at least one plasticizer ranges from 5% to 30% by weight relative to the solid weight of the at least one halogenated polymer used in the process.

85. The optical polymer according to claim 84, wherein the effective amount of the at least one plasticizer ranges from 2% to 20% by weight relative to the solid weight of the at least one halogenated polymer used in the process.

86. A process of making an optical polymer film comprising spin coating a solution comprising, in a medium suitable for the spin coating, at least one halogenated polymer and at least one plasticizer, onto a substrate; and then drying the coating solution using a gradual heating profile; wherein the optical polymer film obtained is a substantially microporous free structure and exhibits a low optical loss.

87. The process according to claim 86, wherein the medium suitable for the spin coating comprises at least one halogenated solvent chosen from halogenated polyethers, halogenated trialkyl amines, and halogenated polycyclic compounds.

88. The process according to claim 86, wherein said optical loss is less than approximately 0.5 dB/cm.

89. The process according to claim 88, wherein said optical loss is less than approximately 0.2 dB/cm.

90. The process according to claim 86, wherein the gradual heating profile comprises heating at approximately 60° C. for 10 min, and then approximately 80° C. for 10 min, and approximately 120° C. for 2 hours.

91. The process according to claim 86, wherein the at least one halogenated polymer is in a concentration ranging from 2% to 30% by weight relative to the total weight of the coating solution.

92. The process according to claim 91, wherein the at least one halogenated polymer is in a concentration ranging from 5% to 30% by weight relative to the total weight of the coating solution.

93. The process according to claim 92, wherein the at least one halogenated polymer is in a concentration ranging from 5% to 25% by weight relative to the total weight of the coating solution.

94. The process according to claim 86, wherein the effective amount of the at least one plasticizer ranges from 2% to 50% by weight relative to the solid weight of the at least one halogenated polymer used in the process.

95. The process according to claim 94, wherein the effective amount of the at least one plasticizer ranges from 5% to 30% by weight relative to the solid weight of the at least one halogenated polymer used in the process.

96. The process according to claim 95, wherein the effective amount of the at least one plasticizer ranges from 2% to 20% by weight relative to the solid weight of the at least one halogenated polymer used in the process.

97. The process according to claim 86, wherein the coating solution comprises from 2% to 30 % by weight of a fluoropolymer, relative to the total weight of the coating solution, from 2% to 50 % by weight of a fluoroplasticizer, relative to the solid weight of the fluoropolymer, and at least one fluorinated solvent.

98. The process according to claim 97, wherein the fluoropolymer is chosen from poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

99. The process according to claim 97, wherein the fluoroplasticizer is chosen from perfluorotetradecahydrophenanthrene oligomers.

100. The process according to claim 97, wherein the at least one fluorinated solvent is chosen from perfluoropolyether, perlfuoro-n-butyl-tetrahydrofuran, and perfluorotributylamine.

101. The process according to claim 86, wherein the coating solution further comprises at least one other polymer chosen from fluoropolymers.

102. The process according to claim 101, wherein the fluoropolymers are chosen from terpolymers of hexafluoropropylene, vinylidene fluoride, and tetrafluoroethylene.

103. The process according to claim 86, wherein the coating solution further comprises at least one inactive filler.

104. The process according to claim 103, wherein the at least one inactive filler is chosen from silica, coated silica, coated silica nanoparticles and other metal oxide compounds.

105. An optical device comprising at least one optical polymer comprising at least one halogenated polymer and at least one plasticizer in an amount effective to produce said optical polymer having a substantially microporous free structure, wherein said optical polymer exhibits an optical loss of less than approximately 0.5 dB/cm.

106. The optical device according to claim 105, wherein said optical loss is equal to or less than approximately 0.2 dB/cm.

107. The optical device according to claim 105, chosen from active waveguide, passive waveguide, fibers, lens, pellicles, coatings, and displays.

108. The optical device according to claim 107, wherein the active waveguide and the passive waveguide are chosen from waveguides with an optical wavelength ranging from 800 nm to 3000 nm.

109. The optical device according to claim 108, wherein the active waveguide and the passive waveguide are chosen from waveguides with an optical wavelength ranging from 1200 nm to 1700 nm.
